(19) United States
(12) Patent Application Publication
(10) Pub. No.: US 2014/0240143 A1
(43) Pub. Date: Aug. 28, 2014

(54) VEHICLE MONITORING SYSTEM AND DEVICE

(71) Applicant: ATrack Technology Inc., Taipei City (TW)

(72) Inventor: PO-CHING WU, Taipei City (TW)

(73) Assignee: ATrack Technology Inc., Taipei City (TW)

(21) Appl. No.: 14/179,597

(22) Filed: Feb. 13, 2014

(30) Foreign Application Priority Data
Feb. 27, 2013 (TW) 102203678

(51) Int. Cl. G08C 17/02; H04W 4/00

(52) U.S. Cl. CPC G08C 17/02; H04W 4/008
USPC 340/870.07; 455/41.2

(57) ABSTRACT

A vehicle monitoring system includes a wireless peripheral sensor and a vehicle monitoring device. The vehicle monitoring device includes a vehicle monitoring module and a short-range wireless communication module. The short-range wireless communication module is used to perform short-range data communication with the wireless peripheral sensor, so as to achieve the short-range wireless communication and control between the vehicle monitoring device and wireless peripheral sensor.

### CROSS-REFERENCES TO RELATED APPLICATIONS

This application claims the priority of Taiwanese patent application No. 102203678, filed on Feb. 27, 2013, which is incorporated herewith by reference.

### BACKGROUND OF THE INVENTION

1. Field of the Invention

The present invention relates to a vehicle monitoring system and a vehicle monitoring device, more particularly to a vehicle monitoring system and device with short-range wireless communication module.

2. The Prior Arts

The On-Board Diagnostics (OBD) system is a computer system installed in a vehicle to monitor the pollutions produced by the vehicle and the engine performance of the vehicle. When the exhaust control unit malfunctions, the OBD system generates a signal to inform the vehicle owner about the malfunctioned exhaust control unit. In this way, the vehicle owner can send his vehicle to the maintenance service in time to prevent the vehicle from further polluting the environment.

As the communication technology advances and the cost of its related electronic components lowers, many plug and play vehicle tracking and monitoring devices became available on the market. Except from monitoring the pollution produced by the vehicle and operation of the engine, these devices have been upgraded to equip with many other functions as well. For example, the vehicle tracking and monitoring devices on the market can also monitor parameters such as the position and the engine control unit (ECU) parameters of the vehicle. In this way, management units can track and manage the vehicles strategically through the background system.

Although the position and the ECU parameters of the vehicle can be obtained easily through the vehicle tracking devices and the background system, these parameters belong to the remote monitoring of vehicle parameters. When it comes to short-range wireless communication and control, in other words, monitoring of the parameters that are more needed by the drivers, the communication and control of such parameters are still insufficient, and the pairing and collaboration between vehicle tracking devices and surrounding smart electronic devices are also insufficient.

Due to the above reasons, it is the urgent need of the industry to develop a vehicle tracking device with short-range wireless communication and control function. In addition to the conventional functions, the vehicle tracking devices with short-range wireless communication function enables convenient applications and control of communication via near field communication technology such as Bluetooth and Radio Frequency Identification (RFID).

### SUMMARY OF THE INVENTION

A primary objective of the present invention is to provide a vehicle monitoring system with short-range wireless communication module.

For achieving the foregoing objective, the present invention provides a vehicle monitoring system including a wireless peripheral sensor and a vehicle monitoring device. The vehicle monitoring device includes a vehicle monitoring module and a short-range wireless communication module. The short-range wireless communication module is electrically connected to the vehicle monitoring module. The short-range wireless communication module is used to perform short-range data communication with the wireless peripheral sensor(s), so as to achieve short-range wireless communication and control between the vehicle monitoring device and the wireless peripheral sensor(s).

Another objective of the present invention is to provide a vehicle monitoring device with short-range wireless communication module.

For achieving the foregoing objective, the present invention provides a vehicle monitoring device including a vehicle monitoring module and a short-range wireless communication module. The short-range wireless communication module is electrically connected to the vehicle monitoring module.

According to an embodiment of the present invention, the vehicle monitoring system and the short-range wireless communication module employed in the vehicle monitoring system can be one or selected combination of the following: a Bluetooth module, a WiFi module, a Sub-1 GHz RF module, a Near Field Communication (NFC) module, a Zigbee module, a RFID module, an infrared module, a microwave module and an ultra wide-band (UWB) module.

According to an embodiment of the present invention, the wireless peripheral sensor(s) employed in the vehicle monitoring system can be one or selected combination of the following: a wireless vehicle entry control sensor, a wireless physiological sensor, a wireless tag panic button, a wireless relay, a wireless tire pressure sensor, a fuel level sensor, a temperature sensor, a door sensor, a fuel cap sensor, a doze sensor, and a wireless sensor network (WSN) related sensors.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing a vehicle monitoring system of the present invention;

FIG. 2 is a schematic view showing a vehicle monitoring device of the present invention;

FIG. 3 is a schematic view showing the first embodiment of the vehicle monitoring system according to the present invention;

FIG. 4 is a schematic view showing the second embodiment of the vehicle monitoring system according to the present invention;

FIG. 5 is a schematic view showing the third embodiment of the vehicle monitoring system according to the present invention;

FIG. 6 is a schematic view showing the fourth embodiment of the vehicle monitoring system according to the present invention, where the vehicle monitoring system is used with an electronic toll collection (ETC) system;

FIG. 7 is a schematic view showing the fifth embodiment of the vehicle monitoring system according to the present invention, where the vehicle monitoring system is used to perform secure data transmission between vehicles;

FIG. 8 is a schematic view showing the sixth embodiment of the vehicle monitoring system according to the present invention, where the vehicle monitoring system is used to perform data communication between vehicle and roadside devices; and

FIG. 9 is a schematic view showing the seventh embodiment of the vehicle monitoring system according to the present invention.

### DETAILED DESCRIPTION OF THE PREFERRED EMBODIMENTS

A vehicle monitoring system and a vehicle monitoring device are disclosed in the present invention. The vehicle monitoring system and the vehicle monitoring device provided in the present invention not only can monitor parameters such as the position, and the ECU parameters of the vehicle, but also can perform short-range data communication with nearby wireless peripheral sensor(s). With the vehicle monitoring system and the short-range wireless communication module employed in the vehicle monitoring device, short-range wireless communication and control can be achieved. The embodiments described hereafter are not to limit the implementation method, environment or application of the present invention; hence, the embodiments in the disclosure are for illustrative purpose only. The accompanying drawings are included to provide a further understanding of the invention, and are incorporated in and constitute a part of this specification. The drawings illustrate embodiments of the invention and, together with the description, serve to explain the principles of the invention. Any non-related elements have been omitted in the drawings. In addition, the relative size between elements has not been drawn according to the actual dimension for the sake of clarity.

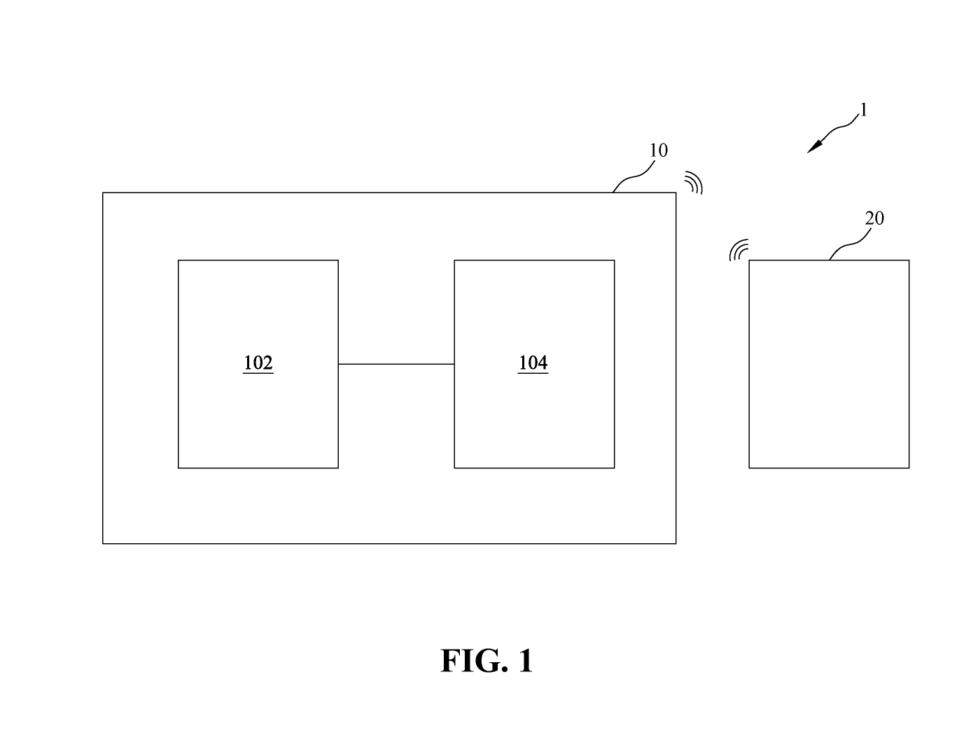

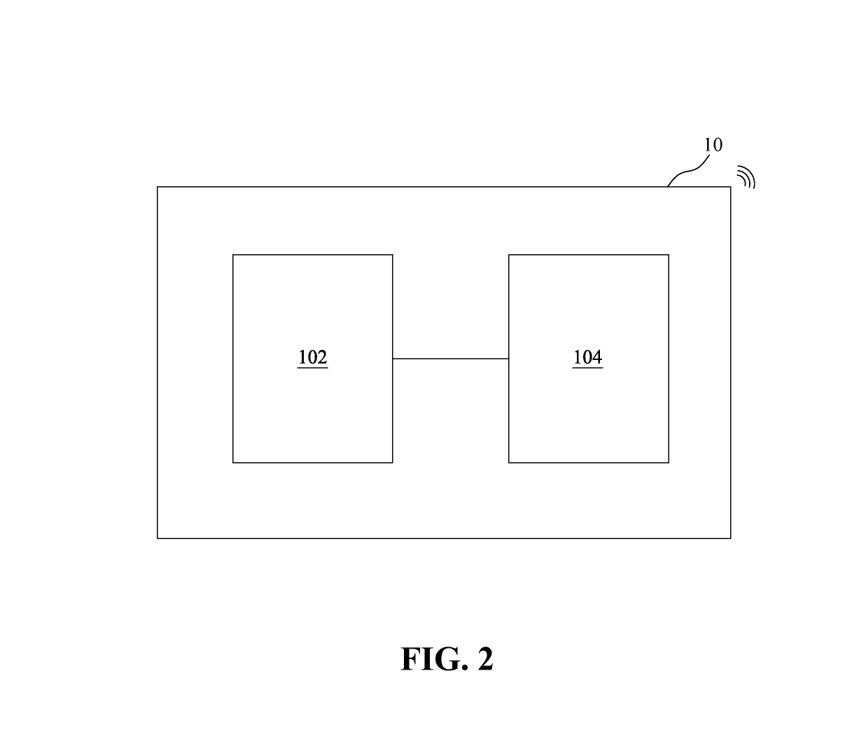

FIG. 1 and FIG. 2 are the schematic diagrams showing the vehicle monitoring system 1 and the vehicle monitoring device 10 of the present invention. As shown in FIG. 1 and FIG. 2, the vehicle monitoring system 1 includes the vehicle monitoring device 10 and a wireless peripheral sensor 20. The vehicle monitoring device 10 includes a vehicle monitoring module 102 and a short-range wireless communication module 104, in which the short-range wireless communication module 104 is electrically connected to the vehicle monitoring module 102.

The vehicle monitoring module 102 employed in the vehicle monitoring device 10 is an electronic module used to position, tack and monitor vehicle status in the automatic vehicle location (AVL) field. The vehicle monitoring module 102 positions vehicles through GPS and/or signals from base station. Then, parameters such as the position, and the ECU parameters of the vehicle are sent to mobile phones, smart phones, computers, monitoring devices and background systems via GSM/GPRS or other long-distance data communication method including 3G and Long Term Evolution (LTE). In this way, vehicle status can be tracked and monitored.

The vehicle monitoring system 1 and the vehicle monitoring device 10 differs from the conventional devices in that: a short-range wireless communication module 104 is employed in the vehicle monitoring system 1 and the vehicle monitoring device 10 of the present invention. The vehicle monitoring device 10 performs short-range data communication with the wireless peripheral sensor(s) 20 through the short-range wireless communication module 104, so as to achieve short-range wireless communication and control between the vehicle monitoring device 10 and the wireless peripheral sensor(s) 20.

In other words, the vehicle monitoring system 1 and the vehicle monitoring device 10 of the present invention not only can position, track and monitor vehicle status, but also have the ability to perform short-range wireless communication and control.

The short-range wireless communication module 104 employed in the vehicle monitoring system 1 and the vehicle monitoring device can be one or selected combination of the following: a Bluetooth module, a WiFi module, a Sub-1 GHz RF module, a NFC module, a Zigbee module, a RFID module, an infrared module and a microwave module. However, the types of the short-range wireless communication module 104 should not be limited only to the modules listed above. Any other module that functions as the short-range wireless module 104 is considered to be within the scope of the present invention.

In addition, the wireless peripheral sensor(s) 20 of the vehicle monitoring system 1 can be one or the combination of the following: a wireless vehicle entry control sensor, a wireless physiological sensor, a wireless panic button, a wireless relay, a wireless tire pressure sensor, a fuel level sensor, a temperature sensor, a door sensor, a fuel cap sensor and a doze sensor. However, the types of the wireless peripheral sensors 20 should not be limited only to the modules listed above. Any other sensor that functions as the wireless peripheral sensor 20 is considered to be within the scope of the present invention.

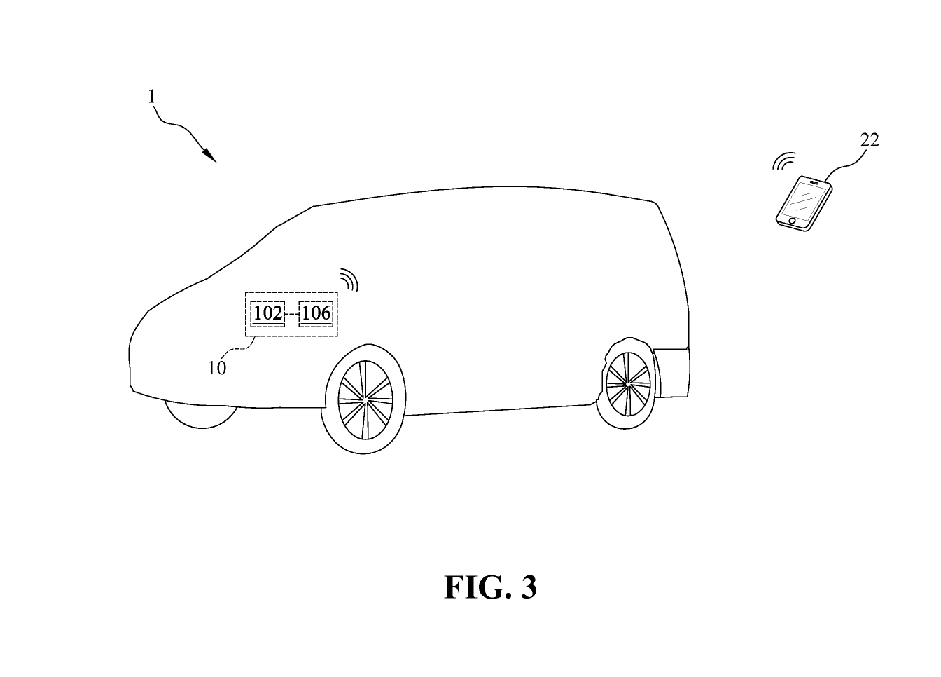

FIG. 3 is a schematic diagram showing the first embodiment of the vehicle monitoring system 1 according to the present invention. In the first embodiment, the vehicle monitoring system 1 includes the vehicle monitoring device 10 and a smart phone 22. The vehicle monitoring device 10 is installed in the vehicle, and the smart phone 22 is the wireless peripheral sensor 20.

Herein, the vehicle monitoring device 10 further includes a vehicle monitoring module 102 and a Bluetooth module 106. The vehicle monitoring module 102 is electrically connected to the Bluetooth module 106. In the first embodiment, the Bluetooth module serves as the short-range wireless communication module 104.

Short-range wireless data communication is performed between the vehicle monitoring device 10 and smart phone 22 via the Bluetooth module 106. To be more specific, short-range wireless data communication is performed between the vehicle monitoring device 10 and smart phone 22 via the Bluetooth module 106 of the vehicle monitoring device 10 and the Bluetooth module (not illustrated) of the smart phone 22.

With an appropriate application (APP), smart phone 22 can display parameters such as the position, speed, acceleration and OVD port of the vehicle on its display screen, thereby achieving short-range wireless communication between the vehicle monitoring device 10 and the smart phone 22.

As for the wireless peripheral sensor 20, there are many other choices than the smart phone 22 mentioned above. Besides from the smart phone 22, electronic devices with Bluetooth module such as tablet computer and navigation devices are also within the scope of the present invention. The method of implementation of such devices depends on the actual situation.

A fact worth mentioning is that the number of the wireless peripheral sensor 20 is not limited to one. In other words, wireless communication and control should not be limited only between one vehicle monitoring device 10 and one wireless peripheral sensor 20. With appropriate arrangement and design, wireless communication and control can be performed between one vehicle monitoring device 10 and multiple wireless peripheral sensors 20.

Take first embodiment as an example, parameters such as the location and the ECU parameters of the vehicle can be displayed simultaneously on the smart phone 22 and other electronic devices like tablet computers and navigation devices, provided that they are installed with the appropriate APP.

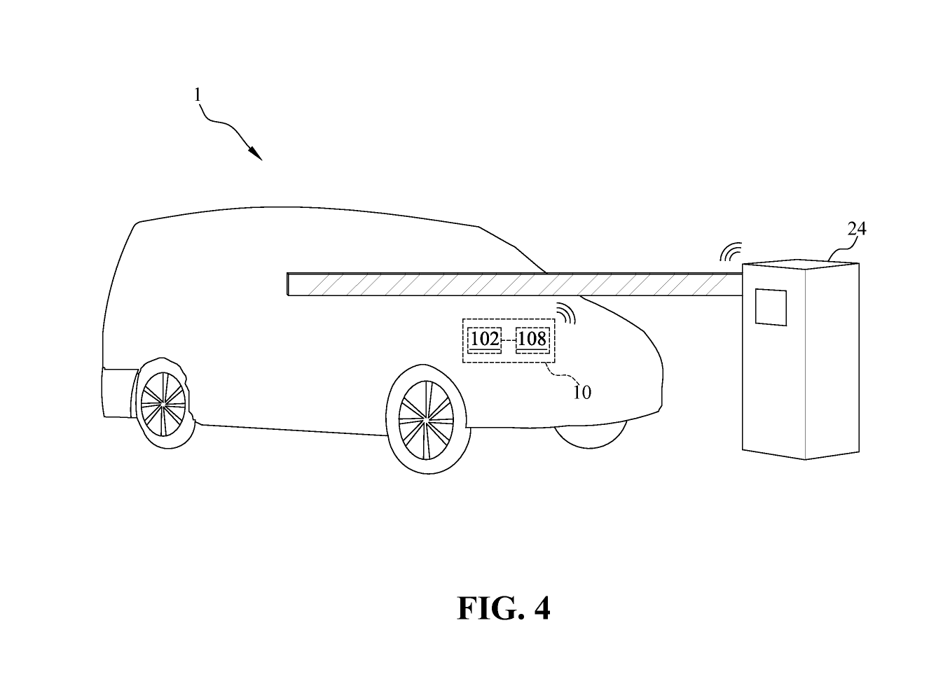

FIG. 4 is a schematic diagram showing the second embodiment of the vehicle monitoring system 1 according to the present invention. In the second embodiment, the vehicle monitoring system 1 includes the vehicle monitoring device 10 and a wireless vehicle entry control sensor 24. The vehicle monitoring device 10 is installed in the vehicle, and the wireless vehicle entry control sensor 24 is the wireless peripheral sensor 20.

Herein, the vehicle monitoring device 10 further includes a vehicle monitoring module 102 and a RFID module 108. The vehicle monitoring module 102 is electrically connected to the RFID module 108. In the second embodiment, the RFID module serves as the short-range wireless communication module.

Short-range wireless data communication is performed between vehicle monitoring device 10 and the wireless vehicle entry sensor 24 via the RFID module 108. To be more specific, short-range wireless data communication is performed between vehicle monitoring device 10 and the wireless vehicle entry sensor 24 via the RFID module 108 of the vehicle monitoring device 10 and the RFID module (not illustrated) of the wireless vehicle entry sensor 24, thereby achieving short-range wireless control between vehicle monitoring device 10 and wireless vehicle entry sensor 24.

With the RFID technology, wireless vehicle entry control sensor sends out an identification code, and then receives and demodulates the identification code from the vehicle monitoring device 10. In this way, vehicle entry control is achieved. With the configuration provided in the second embodiment, vehicle access to the parking lot can be managed with the RFID module 108 of the vehicle monitoring device 10. Vehicles installed with the vehicle monitoring device 10 employing the RFID module 108 can have free access to the restricted area. Thus, the use of additional vehicle entry card can be eliminated, and the production cost of the remote controller can be saved. In addition, the entry and exit time of vehicles can be recorded efficiently, and the management of the vehicle access becomes more efficient as well.

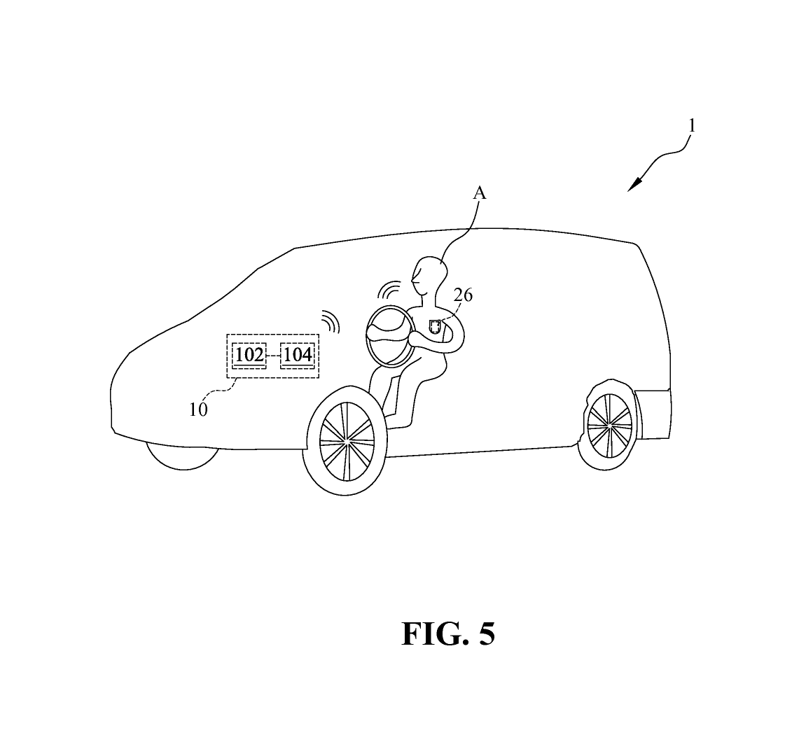

FIG. 5 is a schematic diagram showing the third embodiment of the vehicle monitoring system 1 according to the present invention. In the third embodiment, the vehicle monitoring system 1 is used to monitor the physiological status of the driver/passengers. The vehicle monitoring system 1 according to the third embodiment includes a vehicle monitoring device 10 and a wireless physiological status sensor 26.

Herein, the vehicle monitoring device 10 further includes a vehicle monitoring module 102 and a short-range wireless communication module 104, in which the vehicle monitoring module 102 is electrically connected to the short-range wireless communication module 104. According to the third embodiment of the present invention, the short-range wireless communication module 104 of the vehicle monitoring system 1 can be a Bluetooth module, a WiFi module, a Sub-1 GHz RF module, a NFC module, a Zigbee module, a RFID module or any other short-range wireless communication module 104. The selection of the module can be based on the actual situation.

In the third embodiment, the vehicle monitoring device 10 is installed inside the vehicle. The wireless physiological sensor 26 can be placed on the driver/passenger A, or can also be installed on other objects such as the steering wheel. By monitoring the pulse, breathe and skin condition of the driver/passenger A, the wireless physiological sensor 26 can monitor the physiological status and condition of the driver/passenger A. Then, short-range wireless data communication is performed with short-range wireless communication methods, such as Bluetooth, WiFi, Sub-1 GHz RF, NFC, Zigbee, RFID, infrared or microwave, to send the information acquired to the short-range wireless communication module 104 of the vehicle monitoring device 10. In this way, the physiological information of the driver/passenger A can be sent to phones, smart phones, computers, monitoring devices and background system. When the status of the driver/passenger A is determined to be abnormal, a safety system is then activated. In addition, with the configuration according to the third embodiment, the system can also catch drunk driving in time and can warn the driver/passenger A not to do so.

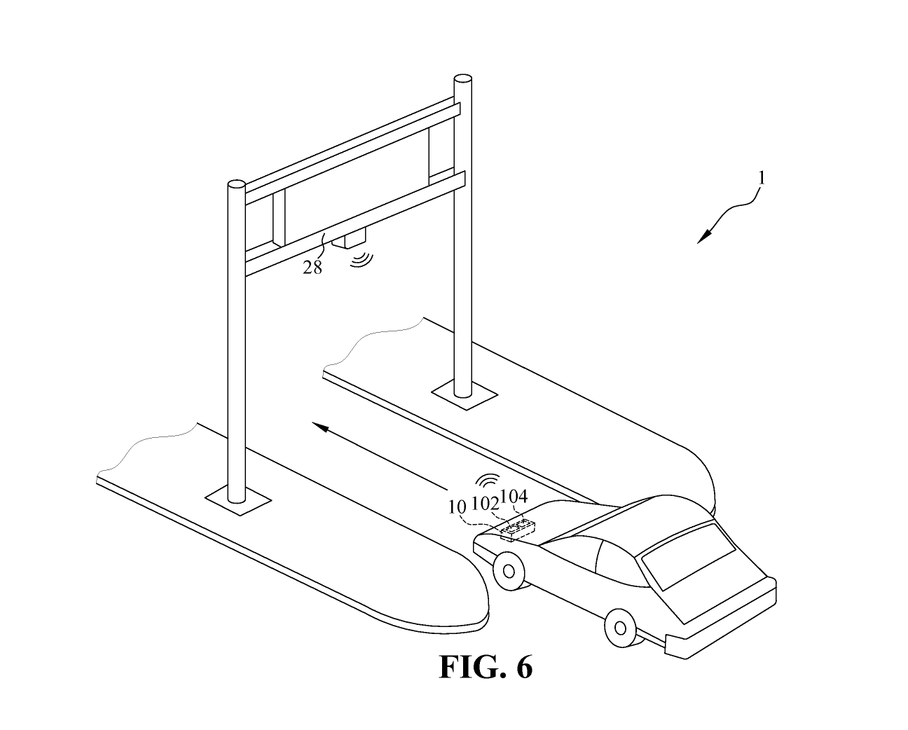

FIG. 6 is the schematic diagram showing the fourth embodiment of the vehicle monitoring system 1 according to of the present invention, in which the vehicle monitoring system 1 is used together with an electronic toll collection (ETC) system. In the fourth embodiment, the vehicle monitoring system 1 includes a vehicle monitoring device 10 and an ETC wireless transmission sensor 28.

Herein, the vehicle monitoring device 10 further includes a vehicle monitoring module 102 and a short-range wireless communication module 104, in which the vehicle monitoring module 102 is electrically connected to the short-range wireless communication module 104. In the fourth embodiment, the short-range wireless communication module 104 of the vehicle monitoring system 1 can be a RFID module, an infrared module, a microwave module or any other types of short-range wireless communication module 104. The selection of the modules can be based on the actual situation.

The vehicle monitoring system 1 sends and receives signals via the ETC wireless transmission sensor 28 to perform short-range wireless data communication with the short-range wireless communication module 104 of the vehicle monitoring device 10. In this way, a unique code inside the vehicle monitoring device 10 is identified, so as to determine the vehicle type for toll fee calculation.

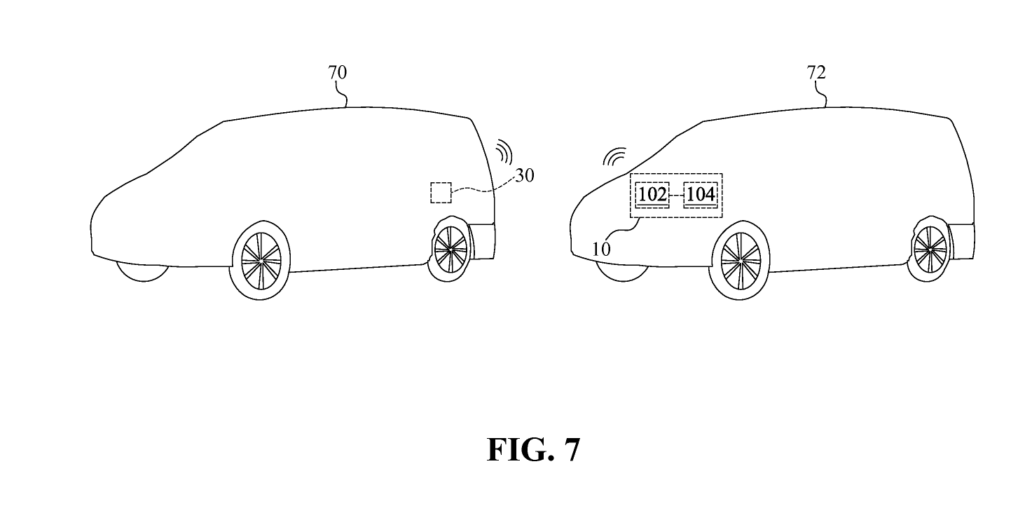

FIG. 7 is a schematic diagram showing the fifth embodiment of the vehicle monitoring system 1 according to the present invention, in which the vehicle monitoring system 1 is used together with a vehicle to vehicle (V2V) secure data transmission. In the fifth embodiment, the vehicle monitoring system 1 includes a vehicle monitoring device 10 and a vehicle wireless sensor 30.

Herein, the vehicle monitoring device 10 further includes a vehicle monitoring module 102 and a short-range wireless communication module 104, in which the vehicle monitoring module 102 is electrically connected to the short-range wireless communication module 104. In the fifth embodiment, the short-range wireless communication module 104 of the vehicle monitoring system 1 can be a WiFi module, or any other types of short-range wireless communication module 104. The selection of the module can be based on the actual situation.

With the vehicle wireless sensor 30, the vehicle monitoring system 1 sends and receives signals to perform short-range wireless data communication with the short-range wireless communication module 104 of the vehicle monitoring device 10. In this way, communication is allowed between vehicle 70 and vehicle 72. For example, the vehicle wireless sensor 30 sends out information about the speed and direction of travel of vehicle 70 through methods similar to radio, so vehicle 72 can avoid bumping into vehicle 70, thereby preventing occurrence of traffic accidents.

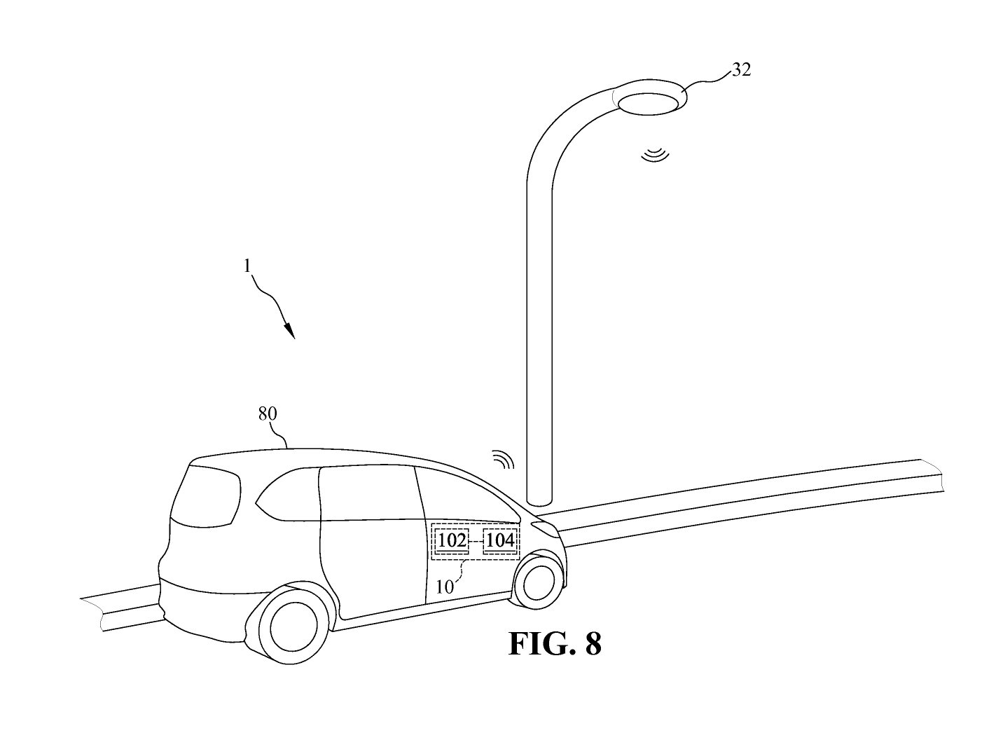

FIG. 8 is a schematic diagram showing the sixth embodiment of the vehicle monitoring system 1 according to the present invention, in which the vehicle monitoring system 1 is used with a vehicle to roadside (V2R) unit data transmission. In the sixth embodiment, the vehicle monitoring system 1 includes a vehicle monitoring device 10 and a roadside wireless sensor 32.

Herein, the vehicle monitoring device 10 further includes a vehicle monitoring module 102 and a short-range wireless communication module 104, in which the vehicle monitoring module 102 is electrically connected to the short-range wireless communication module 104. In the sixth embodiment, the short-range wireless communication module 104 of the vehicle monitoring system 1 can be a WiFi module, or any other types of short-range wireless communication module 104. The selection of the modules can be based on the actual situation.

With the roadside wireless sensor 32, the vehicle monitoring system 1 sends and receives signals to perform short-range wireless data communication with the short-range wireless communication module 104 of the vehicle monitoring device 10. In this way, communication is allowed between vehicle 80 and roadside wireless sensor 32.

Emergency vehicle alert can be sent to the driver through the data communication between vehicle 80 and the roadside wireless sensor 32. In this way, the driver can be alerted in advance when there are emergency vehicles around, and the driver can be guided into the low speed vehicle lanes or to the side of the road to make way for the emergency vehicles.

In addition, construction alert can also be sent to the driver through the data communication between vehicle 80 and the roadside wireless sensor 32. Construction vehicles or heavy machinery can send the construction information to the vehicle 80 that is approaching the construction area through communication network. At the same time, speed limit and detour information are also provided to the driver.

Furthermore, information such as road congestion, traffic accidents alerts, weather, road guide, motorcycle approaching alert can also be sent to the driver far ahead via the short-range wireless data communication between the roadside wireless sensor 32 and the vehicle monitoring device 10, thereby accomplishing V2R data transmission.

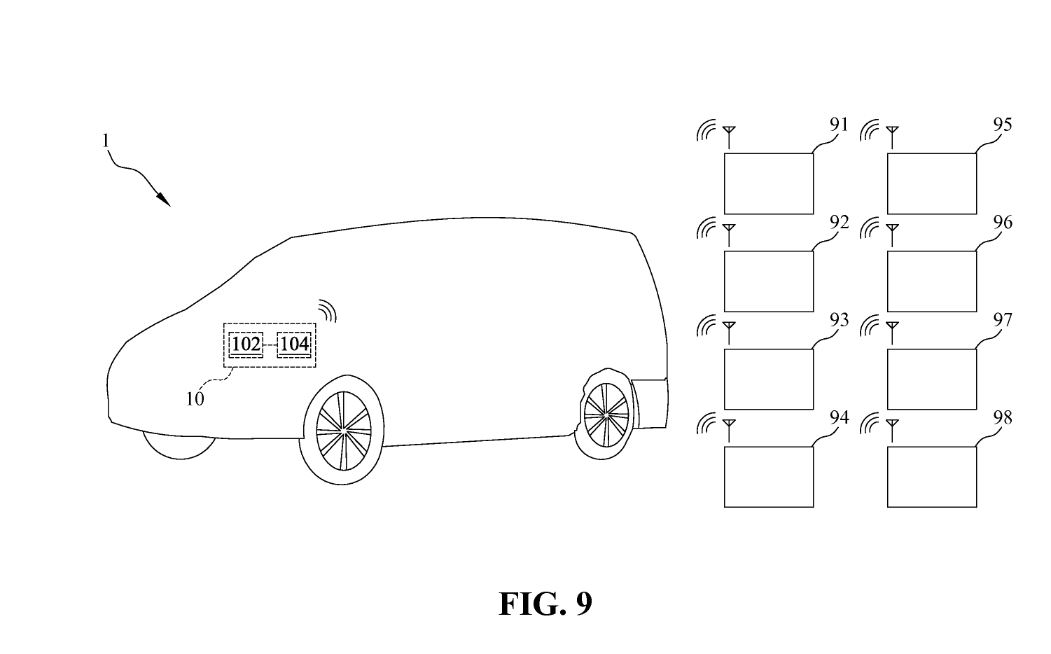

FIG. 9 is a schematic diagram showing the seventh embodiment of the vehicle monitoring system 1 according to the present invention. In the seventh embodiment, the vehicle monitoring system 1 includes a vehicle monitoring device 10, a wireless tag panic button 91, a wireless relay 92, a wireless tire pressure sensor 93, a fuel level sensor 94, a temperature sensor 95, a door sensor 96, a fuel cap sensor 97 and a doze sensor 98. Herein, item 91-98 are the wireless peripheral sensors, and the number and selection of the sensors that are used in the seventh embodiment can be based on the actual situation.

The vehicle monitoring device 10 is installed inside the vehicle, and includes a vehicle monitoring module 102 and a short-range wireless communication module 104. The short-range wireless communication module 104 can be a Bluetooth module, a WiFi module, a Sub-1 GHz RF module, a NFC module, a Zigbee module or a RFID module. The selection of the short-range wireless communication module 104 can be based on the actual situation.

The wireless tag panic button 91 is a short-range wireless emergency remote device which performs short-range wireless data communication with the vehicle monitoring device 10. Vehicle monitoring device 10 captures the digital/analog data sent from the wireless tag panic button 91 through wireless communication, so as to achieve short-range wireless control. For example, when the user activates the wireless tag panic button 91, the vehicle monitoring device 10 is also activated to send out corresponding output. The corresponding output can be activating the vehicle alarm, or sending out corresponding emergency notice to the background system.

Short-range wireless data communication is performed between the wireless relay 92 and the vehicle monitoring device 10. With the short-range data communication, vehicle monitoring device 10 is able to transmit digital/analog data to the wireless relay 92, thereby achieving short-range wireless control. For example, the user can send out digital/analog control signal to enable/disable the wireless relay 92 via the vehicle monitoring device 10. In this way, desired control mode can be selected.

Short-range wireless data communication is performed between the wireless tire pressure sensor 93 and the vehicle monitoring device 10. With the short-range wireless data communication, vehicle monitoring device 10 is able to capture the digital/analog data sent from the wireless tire pressure sensor 93, thereby achieving short-range wireless control. For example, vehicle monitoring device 10 receives and captures the digital/analog signal sent from the wireless tire pressure sensor 93, so the real-time information of tire pressure is acquired by the vehicle monitoring device 10. Then, according to the actual implementation methods, the tire pressure data/information is displayed on the monitor, smart phone, tablet computer or background system.

Short-range wireless data communication is performed between the fuel level sensor 94 and the vehicle monitoring device 10. With the short-range wireless data communication, vehicle monitoring device 10 is able to capture the digital/analog data sent from the fuel level sensor 94, thereby achieving short-range wireless control. For example, vehicle monitoring device 10 receives and captures the digital/analog signal sent from the fuel level sensor 94, so that the real-time information on the fuel level in the fuel tank can be acquired by the vehicle monitoring device 10. Then, according to the actual implementation methods, the fuel level data/information is displayed on the monitor, smart phone, tablet computer or background system.

Short-range wireless data communication is performed between the temperature sensor 95 and the vehicle monitoring device 10. With the short-range wireless data communication, vehicle monitoring device 10 is able to capture the digital/analog data sent from the temperature sensor 95, thereby achieving short-range wireless control. For example, vehicle monitoring device 10 receives and captures the digital/analog signal sent from the temperature sensor 95, so that the real-time information on the temperature of the monitored devices can be acquired by the vehicle monitoring device 10. Then, according to the actual implementation methods, the temperature data/information is displayed on the monitor, smart phone, tablet computer or background system.

Short-range wireless data communication is performed between door sensor 96 and the vehicle monitoring device 10. With the short-range wireless data communication, vehicle monitoring device 10 is able to capture the digital/analog data sent from the door sensor 96, thereby achieving short-range wireless control. For example, vehicle monitoring device 10 receives and captures the digital/analog signal sent from the door sensor 96, so that the real-time information on the door status can be acquired by the vehicle monitoring device 10. Then, according to the actual implementation methods, the door status data/information is displayed on the monitor, smart phone, tablet computer or background system.

Short-range wireless data communication is performed between the fuel cap sensor 97 and the vehicle monitoring device 10. With the short-range wireless data communication, vehicle monitoring device 10 is able to capture the digital/analog data sent from the fuel cap sensor 97, thereby achieving short-range wireless control. For example, vehicle monitoring device 10 receives and captures the digital/analog signal sent from the fuel cap sensor 97, so that the real-time information on the fuel cap status can be acquired by the vehicle monitoring device 10. Then, according to the actual implementation methods, the fuel cap status data/information is displayed on the monitor, smart phone, tablet computer or background system.

Short-range wireless data communication is performed between the doze sensor 98 and the vehicle monitoring device 10. With the short-range wireless data communication, vehicle monitoring device 10 is able to capture the digital/analog data sent from the doze sensor 98, thereby achieving short-range wireless control. For example, vehicle monitoring device 10 receives and captures the digital/analog signal sent from doze sensor 98, so that the vehicle monitoring device 10 can be notified when the driver is dozing off. If the driver is dozing off, the vehicle monitoring device 10 can take corresponding action immediately. For instance, vehicle monitoring device 10 can activate the alarm, or can send a status message to the smart phone, tablet computer or background system. In this way, the operator receives the message can alert the driver to stay awake in time.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A vehicle monitoring system comprising:
a wireless peripheral sensor; and
a vehicle monitoring device including
a vehicle monitoring module, and
a short-range wireless communication module electrically connected to said vehicle monitoring module,
wherein, said short-range wireless communication module is used to perform short-range data communication with said wireless peripheral sensor, so as to achieve short-range wireless communication and control between said vehicle monitoring device and said wireless peripheral sensor.

2. The vehicle monitoring system according to claim 1, wherein said short-range wireless communication module is a Bluetooth module.

3. The vehicle monitoring system according to claim 1, wherein said short-range wireless communication module is a WiFi module.

4. The vehicle monitoring system according to claim 1, wherein said short-range wireless communication module is a Sub-1 GHz RF module.

5. The vehicle monitoring system according to claim 1, wherein said short-range wireless communication module is a Near Field Communication (NFC) module.

6. The vehicle monitoring system according to claim 1, wherein said short-range wireless communication module is a Zigbee module.

7. The vehicle monitoring system according to claim 1, wherein said short-range wireless communication module is a Radio Frequency Identification (RFID) module.

8. The vehicle monitoring system according to claim 1, wherein said short-range wireless communication module is an infrared module, a microwave module and/or an ultra wide-band (UWB) module.

9. The vehicle monitoring system according to claim 1, wherein said wireless peripheral sensor is a wireless vehicle entry control sensor.

10. The vehicle monitoring system according to claim 1, wherein said wireless peripheral sensor is a wireless physiological status sensor.

11. The vehicle monitoring system according to claim 1, wherein said wireless peripheral sensor is one or the combination of the following: a wireless tag panic button, a wireless relay, a wireless tire pressure sensor, a fuel level sensor, a temperature sensor, a door sensor, a fuel cap sensor, a doze sensor and a wireless sensor network (WSN) related sensor.

12. A vehicle monitoring device, comprising:
a vehicle monitoring module; and
a short-range wireless communication module electrically connected to said vehicle monitoring module.

13. The vehicle monitoring device according to claim 12, wherein said short-range wireless communication module is a Bluetooth module.

14. The vehicle monitoring device according to claim 12, wherein said short-range wireless communication module is a WiFi module.

15. The vehicle monitoring device according to claim 12, wherein said short-range wireless communication module is a Sub-1 GHz RF module.

16. The vehicle monitoring device according to claim 12, wherein said short-range wireless communication module is a Near Field Communication (NFC) module.

17. The vehicle monitoring device according to claim 12, wherein said short-range wireless communication module is a Zigbee module.

18. The vehicle monitoring device according to claim 12, wherein said short-range wireless communication module is a Radio Frequency Identification (RFID) module.

19. The vehicle monitoring device according to claim 12, wherein said short-range wireless communication module is an infrared module, a microwave module and/or an UWB module.
